(19) United States
(12) Patent Application Publication
(10) Pub. No.: US 2003/0136341 A1
(43) Pub. Date: Jul. 24, 2003

(54) Wafer lift pin for manufacturing a semiconductor device

(76) Inventor: Sung-Min Na, Seoul (KR)

Correspondence Address: BAKER & DANIELS, 300 NORTH MERIDIAN STREET, SUITE 2700, INDIANAPOLIS, IN, 46204-1782, US

(21) Appl. No.: 10/341,162

(22) Filed: Jan. 13, 2003

(30) Foreign Application Priority Data
Jan. 14, 2002 (KR) 2002-2093

(51) Int. Cl. B05C 13/00

(52) U.S. Cl. 118/500

(57) ABSTRACT

A wafer lift pin assembly of an apparatus for manufacturing a semiconductor device comprises a lower lift pin being driven up and down by an external driving means; a lower lift pin guide leading the lower lift pin to move up and down; an upper lift pin contacting the lower lift pin, the upper lift pin being driven up and down by the lower lift pin; and an upper lift pin guide leading the upper lift pin to move up and down.

This application claims the benefit of Korean Patent Application No. 2002-02093, filed on Jan. 14, 2002 in Korea, which is hereby incorporated by reference for all purposes as if fully set forth herein.

### BACKGROUND OF THE INVENTION

1. Field of the Invention

The present invention relates to an apparatus for manufacturing a semiconductor device and more particularly, to a wafer lift pin that moves a wafer up and down in a chamber for manufacturing a semiconductor device.

2. Discussion of the Related Art

A development for a new material has been actively performed in the field and diverse large-scale integrated circuit (LSI) such as ultra large-scale integrated circuit (ULSI) has been developed due to a rapid growth of the new material development. That is, because the new material for forming thin films such as an insulating layer, a semiconductor layer and a conductor layer, which constitute a semiconductor device, has been developed widely in the field, the large-scale integrated circuit (LSI) such as the ultra large-scale integrated (ULSI) circuit is available now. The semiconductor devices are generally fabricated by repeated depositing and patterning process. These processes are usually accomplished in a chamber type process module under vacuum condition.

FIG. 1 is a cross-sectional view of a typical chamber type process module for manufacturing a semiconductor device. In FIG. 1, the process module 10 has a chamber 20 and a supply unit 50 for gaseous source material and reaction material. The chamber 20 is a place in which a deposition and patterning process of a wafer surface is performed. The supply unit 50 stores gaseous source material and reaction material and supplies the chamber 20 with these materials to process the surface of a wafer 1. The gaseous source material and the reaction material are supplied into the chamber 20 through the supply pipe 56 that connects the chamber 20 to the supply unit 50. An exhaust pipe 24 is for controlling an interior pressure of the chamber 20 by discharging interior gases of the chamber 20 and a pump “P” is connected to one end of the exhaust pipe 24 for this purpose. A susceptor 30 in the chamber 20 is usually made of graphite or aluminum nitride and the wafer 1 is loaded thereon. The process for a surface treatment of the wafer 1 will be described briefly hereinafter. Once the wafer 1 is loaded on the susceptor 30 from outside of the chamber 20 and then the chamber 20 is shut from the outside atmosphere, an interior condition of the chamber 20 is controlled by the pump “P” at the end of the exhaust pipe 24. Thereafter, the source and reaction material is supplied to the chamber 20 from the supply unit 50 through the supply pipe 56 to process the wafer 1 using a chemical reaction of the source and reaction material.

The injector 22, which is connected to one end of the supply pipe 56, serves to distribute and diffuse the source and reaction material uniformly to all direction in the chamber 20. The susceptor 30 has an inter heater 34 in it to heat the wafer 1 up and thus accelerate the chemical reaction of the source and reaction material. A plurality of lift pins 42 is formed through the susceptor 30 to move the wafer 1 up and down.

FIG. 2 is a perspective view of a susceptor 30 and a plurality of wafer lift pins 42 according to the related art and FIG. 3 is a cross-sectional view of the susceptor 30 and the wafer lift pin 42 taken along I-I of FIG. 2. To describe a typical structure of main parts of the chamber 20 for processing the surface of the wafer 1, the susceptor 30, which has the heater 34 of FIG. 1 in it, is disposed at a center of the chamber 20 and a plurality of lift pins 42 is formed trough the susceptor 30 to move the wafer 1 up and down. The wafer 1 is loaded on the susceptor 30 to be processed and a plurality of guide pins (not shown) is formed around the wafer 1 to prevent the wafer 1 from sliding and falling down off the lift pins 42. The number of the guide pins and the lift pins may respectively be three or four but it can be diversely changed according to many different conditions.

Once the lift pins 42 is moved up by the exterior driving means (not shown), a robot arm (not shown) loads the wafer 1 from the outside of the chamber 20 onto the lift pins 42 and then the wafer 1 is lowered onto a center of the susceptor 30 to be processed. Because the wafer 1 needs to be loaded onto the center of the susceptor 30 for a proper process of the surface of the wafer 1, the guide pins (not shown) are formed around the wafer 1 to help the wafer 1 be positioned in a center of the susceptor 30.

However, the lift pin 42 according to the related art has a single body structure as shown in FIG. 3 and thus has many disadvantages as follows. Firstly, because the related art lift pin 42 has a relatively big diameter of 6 mm approximately, for example, it cannot be used in a heat sensitive process. Secondly, because the diameter of the lift pin 42 is big, there remains marks of the lift pins 42 on the bottom surface of the wafer 1 that the lift pin 42 contact to support the wafer 1. Accordingly, there occurs a difference in a progress of the process between an area “A” and an area “B”. The area “A” is a place that the lift pin 42 contacts and the area “B” is a place that the lift pin 42 does not contact. Usually, those two areas show a very big difference in the progress of the process. The difference in the progress of the process between the area “A” and the area “B” has a bad influence on a uniformity of the semiconductor device and thus deteriorates a quality of the produced semiconductor device. Thirdly, when the lift pin 42 is broken or needs to be replaced by a new one, a whole body of the lift pin 42 should be replaced and this is not economically desirable.

### SUMMARY OF THE INVENTION

Accordingly, the present invention is directed to a wafer lift pin assembly of a manufacturing apparatus for a semiconductor device that substantially obviates one or more of problems due to limitations and disadvantages of the related art.

An advantage of the present invention is to provide a wafer lift pin assembly of an apparatus for manufacturing a semiconductor device that comprises a lower lift pin, a lower lift pin guide, an upper lift pin and an upper lift pin guide.

Another advantage of the present invention is to provide an apparatus for manufacturing a semiconductor device using a wafer that has a process chamber, a susceptor on which the wafer is loaded and a wafer lift pin assembly having a lower lift pin, a lower lift pin guide, an upper lift pin and an upper lift pin guide.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a wafer lift pin assembly of an apparatus for manufacturing a semiconductor device comprises a lower lift pin being driven up and down by an external driving means; a lower lift pin guide leading the lower lift pin to move up and down; an upper lift pin contacting the lower lift pin, the upper lift pin being driven up and down by the lower lift pin; and an upper lift pin guide leading the upper lift pin to move up and down.

A diameter of the upper lift pin is between 1.5 mm and 2.5 mm and a diameter of the lower lift pin is between 2.5 mm and 3.5 mm. The external driving means is selected from an air cylinder and a motor. The upper and lower lift pin is formed of ceramic material.

An apparatus for manufacturing a semiconductor device using a wafer comprises a chamber where the wafer is processed; a susceptor on which the wafer is loaded; and a wafer lift pin assembly for moving the wafer up and down, the wafer lift pin assembly comprising a lower lift pin being driven up and down by an external driving means; a lower lift pin guide leading the lower lift pin to move up and down; an upper lift pin contacting the lower lift pin, the upper lift pin being driven up and down by the lower lift pin; and an upper lift pin guide leading the upper lift pin to move up and down.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional view of a typical chamber type process module for manufacturing a semiconductor device;

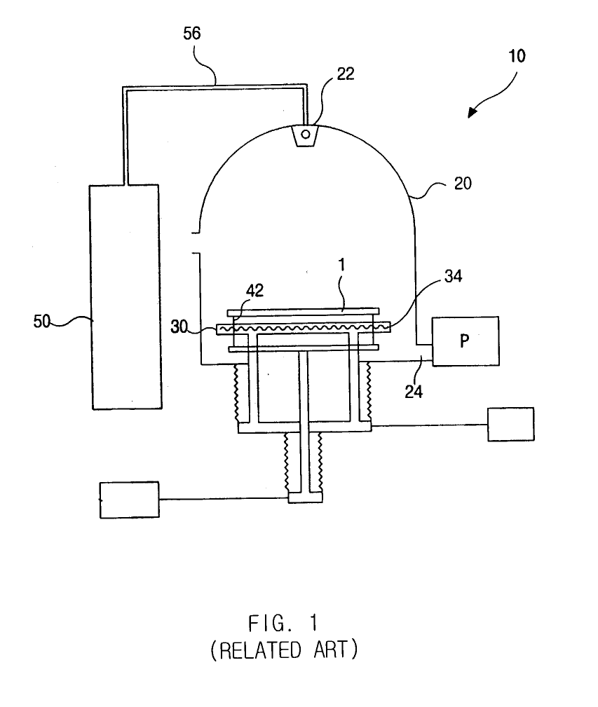

FIG. 2 is a perspective view of a susceptor and a plurality of wafer lift pins according to the related art;

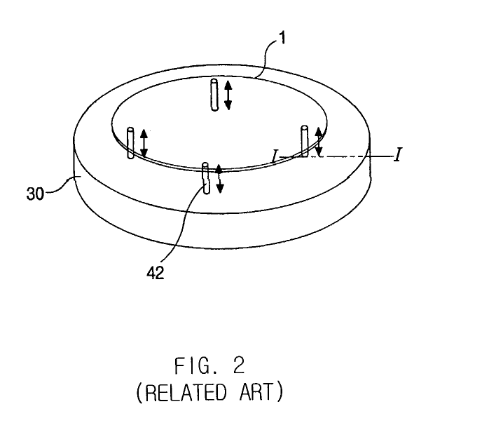

FIG. 3 is a cross-sectional view of the susceptor and the wafer lift pin taken along I-I of FIG. 2;

FIG. 4 is a bottom view of a wafer that is processed in a chamber using a typical wafer lift pin;

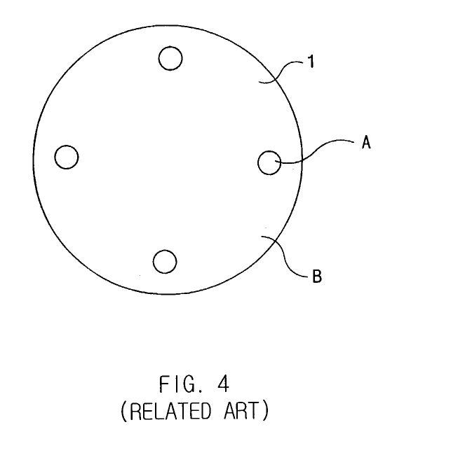

FIG. 5 is a perspective view of a susceptor and a plurality of wafer lift pins according to the present invention;

FIG. 6 is an exploded view of a wafer lift pin assembly of the present invention;

FIG. 7 is a cross-sectional view of the susceptor and the wafer lift pin assembly taken along II-II of FIG. 5;

FIG. 8 is a bottom view of a wafer that is processed in a chamber using the wafer lift pin assembly of the present invention.

### DETAILED DESCRIPTION OF THE ILLUSTRATED EMBODIMENTS

Reference will now be made in detail to the illustrated embodiment of the present invention, which is illustrated in the accompanying drawings.

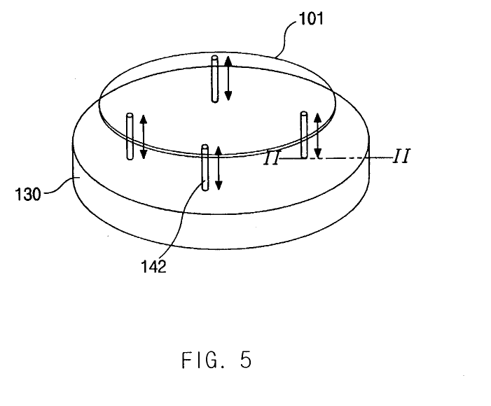

FIG. 5 is a perspective view of a susceptor and a plurality of wafer lift pins according to the present invention. As shown in the figure, a wafer 101 is loaded on the lift pins 142 and kept up by the lift pins 142 for a certain time during a beginning of the loading of the wafer 101. This is for preventing the wafer 101 from being warped by a big temperature difference between the susceptor 130 and the wafer 101 during the beginning of the wafer loading process. That is, because the susceptor 130 has a high temperature owing to a heater (not shown) that is installed into the susceptor 130 and the wafer 101 that is input into the chamber (not shown) from cool exterior condition has a relatively low temperature, an abrupt contact between the susceptor 130 and the wafer 101 in a short time after the input of the wafer 101 into the chamber (not shown) will cause a warpage of the wafer 101 by a heat stress. Accordingly, the wafer 101 needs to be pre-heated before it is loaded on the susceptor 130 to prevent an abrupt delivery of temperature from the susceptor 130 to the wafer 101. A plurality of lift pins 142 that supports the bottom of the wafer 101 can move up and down by an external driving means (not shown). An air cylinder or a motor, for example, may be selected for the exterior driving means. A plurality of guide pins (not shown) is further formed around the wafer 101 to prevent the wafer 101 from sliding away the susceptor 130.

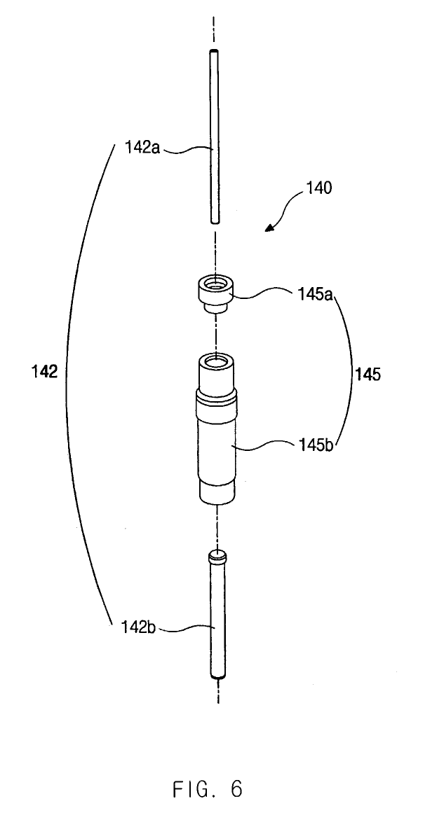

FIG. 6 is an exploded view of a wafer lift pin assembly 140 of the present invention. As shown in FIG. 6, the lift pin assembly 140 of the present invention comprises an upper lift pin 142a, a lower lift pin 142b, an upper lift pin guide 145a and a lower lift pin guide 145b. The upper lift pin guide 145a is for leading the upper lift pin 142a to move up and down and the lower lift pin guide 145b is for leading the lower lift pin to move up and down.

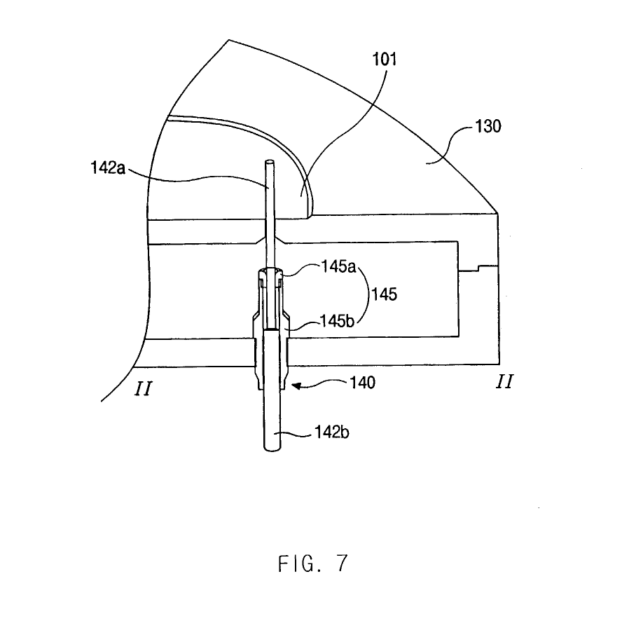

FIG. 7 is a cross-sectional view of the susceptor 130 and the wafer lift pin assembly 140 taken along II-II of FIG. 5. As shown in FIG. 7, the lift pin 142 of the present invention has the upper lift pin 142a and the lower lift pin 142b. The lower lift pin 142b is connected to an external driving means (not shown) and thus moves up and down by the external driving means. If the lower lift pin 142b receives a driving force from the external driving means, it pushes the upper lift pin 142a upward or downward. The upper lift pin guide 145a is assembled to the lower lift pin guide 145b and the assembly 145 of the upper and lower lift pin guides 145a and 145b are attached to an interior of the susceptor 130 as shown in FIG. 7.

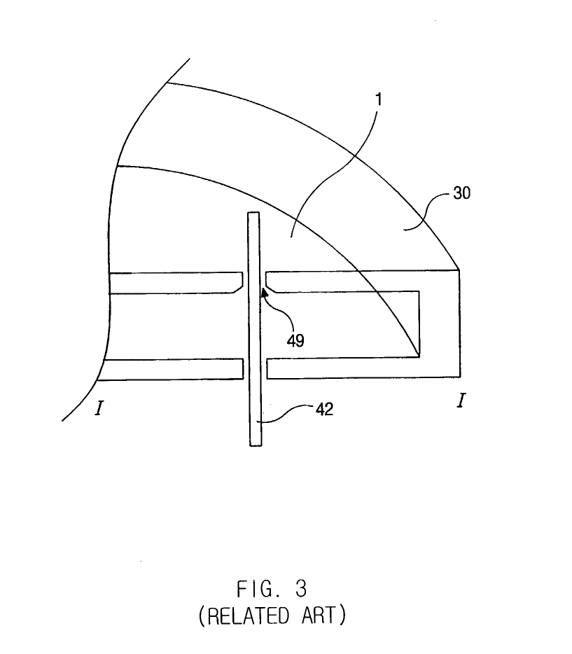

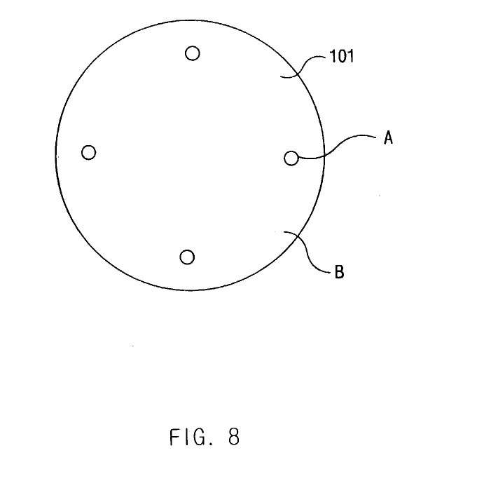

Compared to the related art lift pin, the lift pin 142 of the present invention has advantages as follows. Firstly, the related art lift pin has a relatively big diameter of 6 mm approximately, for example and thus is not proper for a heat sensitive process. To overcome such a disadvantage of the lift pin having a big diameter, the diameter of the lift pin must be reduced. However, if the lift pin is too thin, it cannot stand against the driving force of the external driving means (not shown). Therefore, there is a limit for reducing the diameter of the lift pin. However, in case of the present invention, because the lower lift pin 142b is directly connected to the external driving means to receive a driving force from the external driving means and then pushes up and down the upper lift pin 142a, the diameter of the upper lift pin 142a can be minimized approximately to 2 mm. Accordingly, the lift pin 142 of the present invention can be used even in the heat sensitive process owing to its small diameter. In addition, damage to the lift pin by the heat can be minimized according to a reduction of the diameter of the lift pin 142. Secondly, because the related art lift pin 42 of FIG. 3 has a big diameter, it leaves a relatively big mark on a bottom of the wafer 101 that the lift pin 142 contacts. This causes a local difference in a progress of the process between an area that the lift pin contact and an area that the lift pin does not contact. This difference in the progress of the process on the surface of the wafer 101 has a great influence on a uniformity of the semiconductor device and thus deteriorates a quality of the manufactured semiconductor device. However, because the area on the bottom surface of the wafer 101 that the lift pin 142 contacts can be reduced by minimizing the diameter of the upper lift pin 142a, a bad effect of the mark that the lift pin 142a leaves on the bottom surface of the wafer 101 can be minimized as shown in FIG. 8. An area “A” is a place that the upper lift pin 142a contacts and an area “B” is a place that the upper lift pin 142a does not contact. Accordingly, because the lift pin mark “A” on the bottom surface of the wafer 101 can be minimized according to the present invention, the previously stated problems of the related art lift pin can be avoided. Thirdly, while the whole body of the related art lift pin that has a single-body structure must be replaced by a new one when it is broken or needs to be replaced, only a broken part of the lift pin assembly 140 can be replaced by a new one according to the present invention. For example, if the upper lift pin 142a is broken, only the upper lift pin 142a can be easily replaced by a new one. Accordingly, it is much more favorable economically to use the lift pin 142 of the present invention than the related art lift pin for an economical purpose. Furthermore, when a size and a shape of the lift pin 142 need to be modified according to many changing conditions, only a change of the upper lift pin 142a can simply satisfies the changed conditions.

Though the number of the lift pins 142 of the present invention is four in this preferred embodiment of the present invention, it can be changed diversely according to many different situations and necessities.

As described before, it is easy to change the size and a shape of the lift pin according to changes of the working conditions. In addition, the lift pin mark “A” on the bottom surface of the wafer 101 can be minimized so that the uniform treatment of the wafer 101 can be achieved. Moreover, each part of the lift pin assembly 140 can be more easily replaced when it is broken by selectively replacing only the part that needs to be replaced.

It will be apparent to those skilled in the art that various modifications and variation can be made in the fabrication and application of the present invention without departing from the spirit or scope of the invention. Thus, it is intended that the present invention cover the modifications and variations of this invention provided they come within the scope of the appended claims and their equivalents.

What is claimed is:

1. A wafer lift pin assembly of an apparatus for manufacturing a semiconductor device, comprising:
a lower lift pin being driven up and down by an external driving means;
a lower lift pin guide leading the lower lift pin to move up and down;
an upper lift pin contacting the lower lift pin, the upper lift pin being driven up and down by
the lower lift pin; and
an upper lift pin guide leading the upper lift pin to move up and down.

2. The wafer lift pin assembly according to claim 1, wherein a diameter of the upper lift pin is between 1.5 mm and 2.5 mm.

3. The wafer lift pin assembly according to claim 1, wherein a diameter of the lower lift pin is between 2.5 mm and 3.5 mm.

4. The wafer lift pin assembly according to claim 1, wherein the external driving means is selected from an air cylinder and a motor.

5. The wafer lift pin assembly according to claim 1, wherein the upper and lower lift pin is formed of ceramic material.

6. An apparatus for manufacturing a semiconductor device using a wafer, comprising:
a chamber where the wafer is processed;
a susceptor on which the wafer is loaded; and
a wafer lift pin assembly for moving the wafer up and down, the wafer lift pin assembly comprising:
a lower lift pin being driven up and down by an external driving means;
a lower lift pin guide leading the lower lift pin to move up and down;
an upper lift pin contacting the lower lift pin, the upper lift pin being driven up and down by the lower lift pin; and
an upper lift pin guide leading the upper lift pin to move up and down.

7. The wafer lift pin assembly according to claim 6, wherein a diameter of the upper lift pin is between 1.5 mm and 2.5 mm.

8. The wafer lift pin assembly according to claim 6, wherein a diameter of the lower lift pin is between 2.5 mm and 3.5 mm.

9. The wafer lift pin assembly according to claim 6, wherein the external driving means is selected from an air cylinder and a motor.

10. The wafer lift pin assembly according to claim 6, wherein the upper and lower lift pin is formed of ceramic material.
